(19) United States
(12) Patent Application Publication
(10) Pub. No.: US 2004/0218802 A1
(43) Pub. Date: Nov. 4, 2004

(54) Banknote detecting unit for a banknote distinguishing device

(76) Inventor: Daishi Suzuki, Iwatsuki-shi (JP)

Correspondence Address: Snell & Wilmer L.L.P., 1920 Main Street, Suite 1200, Irvine, CA, 92614-7230, US

(21) Appl. No.: 10/760,594

(22) Filed: Jan. 20, 2004

(30) Foreign Application Priority Data
Jan. 20, 2003 (JP) 2003-011568

(51) Int. Cl. G06K 9/00; G06F 17/60

(52) U.S. Cl. 382/137; 705/45

(57) ABSTRACT

A banknote detecting unit for a banknote distinguishing device includes a transmitting sensor which includes a light emitting section and a light receiving section which are located on opposite sides of a banknote passageway. A reflecting sensor includes a light transmitting section and a light receiving section which are located on the same side of the banknote passageway. A first transmitting sensor is structured by a first axis of a first light emitting section which is at an obtuse angle to the banknote passageway and a first light receiving section which is located on the first axis and is located opposite the first light emitting section. A first reflecting sensor formed from the first light emitting section and a second light receiving section which is located on the same side as the first emitting section.

### BACKGROUND OF THE INVENTION

1. Field of the Invention

The present invention relates to an improved detecting unit for incorporation within a banknote detecting unit or document verification system wherein radiation such as light can detect predetermined information on a document or a banknote for verifying the same.

2. Description of Related Art

In a banknote distinguishing device for distinguishing between genuine or fake banknotes, distinguishing data is usually generated by an optical inspection with light radiation. For example, a transmitting sensor which is structured by a light emitting section and a light receiving section which are located across a banknote passageway and a reflecting sensor which is structured by a light emitting section and a light receiving section located on the same sides are used, with the sensors collecting the sampling data as shown in Japanese Patent No. 3307787.

In the prior art, the transmitting sensor and the reflecting sensor usually each have a light emitting section and a light receiving section. Therefore, the required number of light emitting sections and the light receiving sections are repeated for each sensor. As a result, the banknote distinguishing device can be rather expensive and requires a larger space rather than a compact configuration.

Another example of prior art utilizes a pair of wavelength in Japanese Laid Open Patent Application 2001-195629.

Also, to make the initial settings easy, the banknote distinguishing device, the reflecting sensor and a receiving section are positioned to face towards an emitting section of the transmitting sensor and are located opposite the emitting section relative to the banknote passageway. The emission amount of the emitting section output can be held constant as shown in Japanese Patent No. 3307787. However, generally the receiving section is used for adjustment in the prior art. Therefore, it can be expensive corresponding to the receiving section and must be larger.

Thus, the prior art is still seeking an economical and improved verification sensor unit of a compact configuration.

### SUMMARY OF THE INVENTION

A first purpose of the invention is to reduce the required space for a transmitting section and a reflecting section. A second purpose of this invention is to provide the banknote detecting device which is inexpensive and made up of a transmitting sensor and the reflecting sensor. A third purpose of this invention is to facilitate an initial setting for the transmitting sensor and the reflecting sensor.

This present invention includes the following structure to solve the previous problems. A banknote detecting unit for banknote distinguishing device includes a transmitting sensor which includes a light emitting section and a light receiving section which are located on a light axis of the light emitting section and opposite to the banknote passageway. A reflecting sensor includes a light transmitting section and a light receiving section which are located at one side of the banknote passageway and which are characterized in that, a first transmitting sensor is structured by a first light axis of a first light emitting section which slants to the banknote passageway and a first light receiving section which is located on the first light axis and is located opposite the first light emitting section, a first reflecting sensor which is structured by the first light emitting section and a second light receiving section which is located at the same side of the first light emitting section to the banknote passageway.

In this structure, the distinguishing data of the banknote or document can be sampled when light, which is emitted from the first light emitting section, is received in the light receiving section which is located opposite the first light emitting section to the banknote passageway. The first light receiving section receives the transmitted light through the banknote. Also, the light which is emitted from the first light emitting section is received in the second light receiving section which is located parallel to the first light emitting section. In other words, the second light receiving section receives light which is reflected by the banknote.

The first light emitting section and the first light receiving section form the structure of the first transmitting sensor, and the first light receiving section and the second light receiving section form the structure of the first reflecting sensor. Therefore, the emitting sections are common to the respective first transmitting sensor and the first reflecting sensor. As a result, with this invention the emitting section can be reduced by one element. Accordingly, the sensor's space and the cost are correspondingly reduced.

The present invention employ a first light or optical axis which crosses at an obtuse angle opposite to the banknote traveling direction. In this structure, the light which is emitted from the first light emitting section crosses to the transporting direction of the banknote at the obtuse angle opposite to the banknote traveling direction. Therefore, the light axes of both the first light receiving section and the second light receiving section cross the transporting direction of the banknote at acute angles. In other words, the light axes slant in the transporting direction of the banknote, and the light axes of the light receiving sections face towards an opposite entry of the banknote passageway. Therefore, light which comes from the entry of the banknote passageway is not received at the first light receiving section and the second light receiving section. As a result, the sensors are not influenced by outside light.

The present invention includes a second light emitting section which is located opposite to the first light emitting section to the banknote passageway; the second light emitting section is located on a second light or optical axis in this structure; the light which is emitted from the second light emitting section is received in the second light receiving section when it travels through the banknote. In other words, the second light emitting section and the second light receiving section for the structure of the second transmitting sensor. Therefore, the second emitting section and the first light receiving section structure form the second reflecting sensor.

Accordingly, the second transmitting sensor and the second reflecting sensor are structured, because the second light emitting section is added. Therefore, the light transmitting section and the light receiving section are reduced by two. Accordingly, the sensor's space and the cost are reduced.

The first wavelength light is projected from the first light emitting section, and a second wavelength light is projected from the second light emitting section. In this structure, when the first light receiving section receives the first wavelength light which is emitted from the first light emitting section, the first light emitting section outputs an output based on the first wavelength, and the second light receiving section outputs an output based on the first wavelength.

In other words, the first transmitting sensor and the first reflecting sensor can output a signal based on the first wavelength. When the light receiving sections receive the second wavelength light which is emitted from the second light emitting section, the first light receiving section and the second light receiving section can output a signal based on the second wavelength.

When the wavelengths are different, the light passed through the banknote is filtered. Also the reflected light by the banknote will differ because of the different ink. Accordingly, the first transmitting data is received from the first transmitting sensor based on the first wavelength, the first reflecting data is received from the first reflecting sensor based on the face of the banknote, the second transmitting data is received from the second transmitting sensor based on the second wavelength, and the second reflecting data is received from the second reflecting sensor based on the rear of the banknote. Therefore, the verification accuracy for banknotes and documents is improved, because different sampling data is generated and compared.

The first light emitting section projects infrared rays, and the second light emitting section emits non-infrared rays. In this structure, the infrared rays are emitted from the first light emitting section and non-infrared rays are emitted from the second light emitting section. The non-infrared rays are, for example, radiant lights or ultraviolet rays. In other words, the first transmitting sensor outputs a distinguishing data which is based on the passed infrared rays which transmits in the banknote, the first reflecting sensor outputs a distinguishing data which is reflected by the banknote, the second transmitting sensor outputs a distinguishing data which is based on non-infrared rays and the second reflecting sensor outputs a distinguishing data which is based on non-infrared rays. The emitting element for infrared rays or non-infrared rays (for example, red light) can be an LED and is cheaper. Therefore, the banknote detecting unit can be inexpensive.

The present invention includes a reading controlling unit which, when the first light emitting section emits the rays, a receiving output of the first light emitting section is read, afterwards the emissions from the first light emitting section stop and a second light emitting section emits the rays, and the receiving output of the second receiving section is read; afterwards the receiving output of the first receiving section is read.

In this structure, when the first light emitting section emits radiation, such as light, the receiving data of the first transmitting sensor can be outputted; secondly, the receiving data of the first reflecting sensor is outputted; afterwards, the first light emitting section stops emitting. Next, second light emitting section emits light, and firstly, the receiving data of the second transmitting sensor is outputted; secondly, the receiving data of the second reflecting sensor is outputted; afterwards, the second emitting section stops emitting. In other words, when the first light emitting section emits the light, the second light emitting section does not emit light.

Also, when the second light emitting section emits light, the first light emitting section does not emit. Therefore, the first transmitting sensor and the first reflecting sensor do not receive any effect from the second light emitting section. As a result, the sensors output the receiving data based on the wavelength of the first light emitting section. Also, the second transmitting sensor and the second reflecting sensor do not receive any effect from the first light emitting section. Therefore, the sensors output the receiving data based on the wavelength of the second light emitting section. As a result, the accuracy of verification increases, because the banknote is distinguished based on receiving data which is based on either the wavelength from either the first light emitting section or the second light emitting section.

Also, the first transmitting sensor samples data of the banknote. Afterwards, the first reflecting sensor samples data of the banknote. Then the second transmitting sensor samples data of the banknote. Next the second reflecting sensor samples data of the banknote. Therefore, the reflecting data can be distinguished based on the transmitting data. As a result, the distinguishing accuracy of the banknote further increases. For example, “a watermark” on the document can be distinguished based on the transmitting data, and afterwards the reflecting data is distinguished. The distinguishing verification of determining the “a (??) watermark” increases.

The banknote detecting unit for the banknote distinguishing device includes a first transmitting sensor which is structured by a first light emitting section which is slanted relative to an axis of the banknote passageway and a first light receiving section which is located on the first light axis and is located opposite the first light emitting section across the banknote passageway, a first reflecting sensor which is structured by the first light emitting section and a second light receiving section which is located on the same side of the first light emitting section to the banknote passageway, an emitting amount adjusting unit which adjusts the emitting amount to when the first light emitting section emits the output of the first light receiving section which then becomes a predetermined amount, a receiving outputting adjusting unit which adjusts a gain to the output of the second light receiving section until it becomes a predetermined amount of the second light receiving section.

In this structure, the emitting light from the first light emitting section is received in the first light receiving section which is located opposite the first emitting light to the banknote passageway. Also, the emitting amount is adjusted by the emitting amount adjusting unit as a predetermined amount which is constant to the receiving amount of the first light receiving section. The first light emitting element, the first light receiving element and the protecting cover have a “data spread”. Therefore, “data spread” of the sampling data which is based on the individual difference is prevented.

Also, the gain for the output of the second receiving section is adjusted by the receiving outputting adjusting unit as a predetermined amount becomes the output of the second light receiving section. The receiving element and the protecting cover have “data spread”. Therefore, the sampling data have “data spread”. However, the adjusting prevents such a “data spread”. Therefore, the initial setting of the emitting amount of the first transmitting amount can be automatically adjusted by the emitting amount adjusting unit and the output of the first reflecting sensor is adjusted by the receiving outputting adjusting unit as the output is held constant.

The initial setting is adjusted before factory shipment. Also, the adjusting of the emitting amount can be changed to accommodate any increasing and decreasing of the luminance, including the increasing and the decreasing of the emitting area and the increasing and decreasing of the distance between the light emitting section and the light receiving section.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a perspective view of a banknote distinguishing device which is attached the banknote detecting unit of the embodiment.

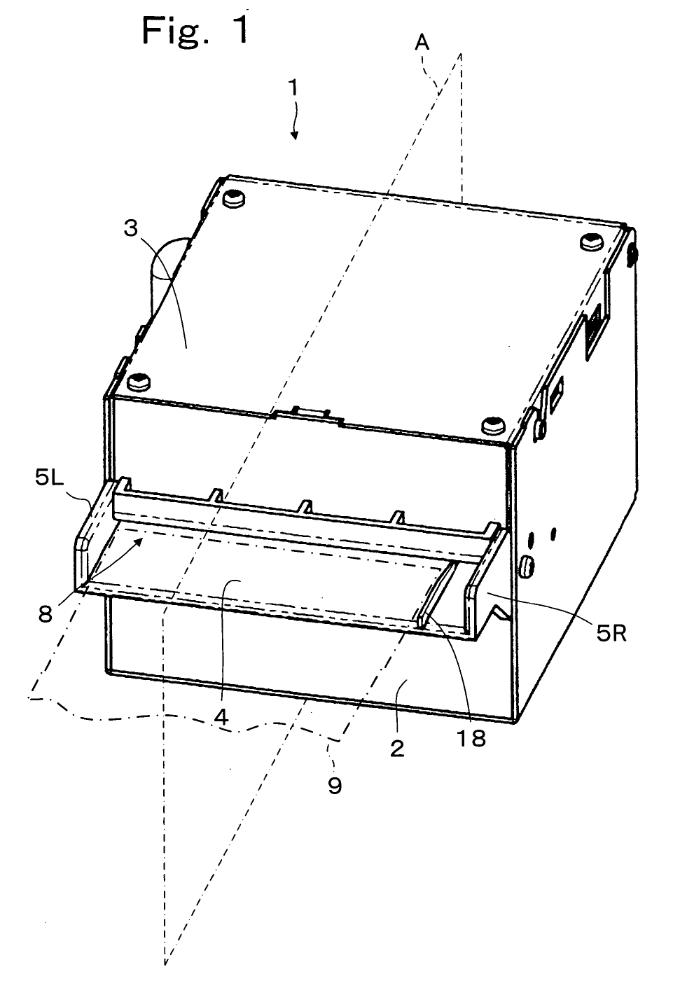

FIG. 2 is a cross-sectional view of along an A section in FIG. 1.

FIG. 3 is an enlarged view of the B section in FIG. 2.

FIG. 4 is an enlarged view of the C section in FIG. 2.

FIG. 5 is a block diagram of a detecting circuit of a banknote detecting section of one embodiment.

FIG. 6 is a timing chart for explaining an operation of the banknote detecting unit of one embodiment.

FIG. 7 is a schematic block diagram for an initial setting of an embodiment of the present invention.

FIG. 8 is a flow chart for an initial setting of the banknote detecting section of an embodiment.

### DETAILED DESCRIPTION OF THE PREFERRED EMBODIMENTS

Reference will now be made in detail to the preferred embodiments of the invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

The present invention is directed to verifying a document by comparing certain known characteristics possessed by a valid document. As described herein, a document is generally a paper document and for purpose of illustration will be described as monetary currency such as banknotes although other forms of documents can be used. Additionally, radiation in the form of light of a specific wavelength can be used to measure the characteristics of a document.

Banknote distinguishing unit 1 which can be installed as a component in conjunction with a cash dispensing machine includes lower member 2 and upper member 3. Upper surface of lower member 2 forms a lower banknote guiding surface 4 which is flat. Lower member 2 includes a right guiding board 5R which is located at the right side and left guiding board 5L which is located at the left side. The distance between right guiding board 5R and left guiding board 5L is slightly wider than the width of an acceptable banknote. The lower section of upper member 3 is inserted between right guiding board 5R and left guiding board 5L. The under surface of the upper member 3 forms a flat banknote guiding surface 6.

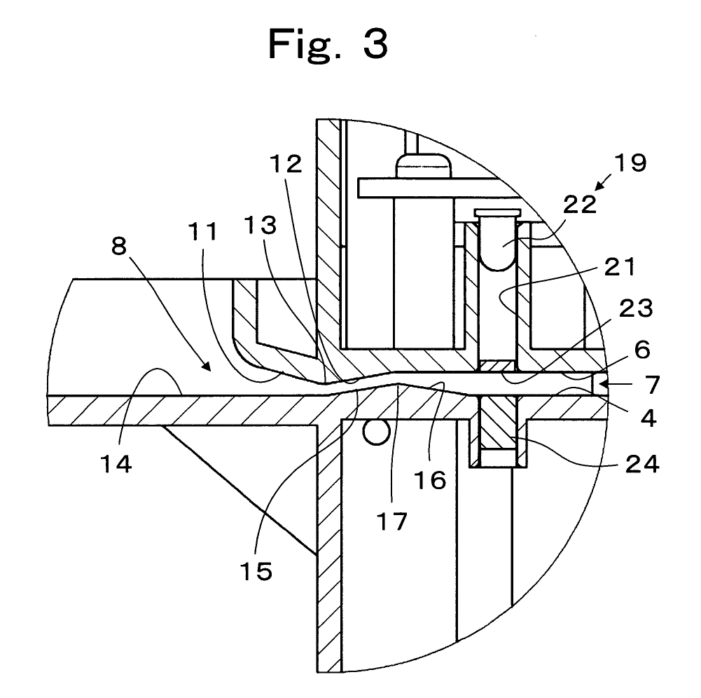

Lower banknote guiding surface 4 and upper banknote guiding surface 6 are located in parallel and have a clearance which can pass a banknote. The clearance is banknote passageway 7. Upper banknote guiding surface 6 includes a downward slanting surface 11 to the transporting direction of banknote 9 which continues to banknote entry 8 and upward slanting surface 12 which continues to downward slanting surface 11 as shown in FIG. 3. Downward projection 13 is formed by downward slanting surface 11 and upward slanting surface 12, and is approximately triangular in cross section.

Lower banknote guiding surface 4 includes a flat surface 14 which is located at banknote entry 8 and second upward slanting surface 15 which is positioned opposite upward slanting surface 12 and continues to flat surface 4. Also, second downward slanting surface 16 continues to second downward slanting surface 16. Upward projection 17 is formed by second upward slanting surface 15 and second downward slanting surface 16, and is also approximately triangular in cross section.

The top (the lower end) of downward projection 13 extends towards the upward projection 17 in the transporting direction of the banknote as shown in FIG. 3 and is slightly overlapped with the upper projection in the up and down direction. Therefore, possible malfunction of the after-mentioned starting sensor 19 which may be based on outside light is prevented.

Banknote guiding rib 18 is parallel to right guiding board 5R, and is located at an area which protrudes towards the outside rather than banknote entry 8 of flat surface 4. Banknote guiding rib 18 is rectangle at a cross-section, and the height is either the same or smaller than the height of banknote passageway 7. The rear end of banknote guiding rib 18 slants and makes flat surface 14 flush with the rear end near banknote entry 8. Banknote guiding rib 18 is used as an indication for a banknote which is narrower than the distance between right guiding board 5R and left guiding board 5L.

Starting sensor 19 is located beside upstream side of the banknote transporting direction at second downward slanting surface 16. Starting sensor 19 includes projecting/receiving section 22 which is located at the bottom (the upper end) of a holding hole 21 of upper member. Protecting cover 23 is fixed at the lower end of keeping hole 21, and is the opening to starting projecting/receiving section.

Starting reflector 24 is mounted on lower member 2 which faces upward to protecting cover 23. Therefore, a beam is projected from projecting/receiving section 22, and crosses banknote passageway 7. Afterwards the beam is reflected by starting reflector 24, and also crosses banknote passageway 7, and is received in the receiving section of receiving section 22. When banknote 9 interrupts the beam of starting sensor 19, the receiving section does not receive the beam. Therefore, the presence of a banknote 9 is detected; afterwards banknote transporting unit 25 is started based on this detection.

Banknote transporting unit 25 is located along banknote passageway 7 downstream of starting sensor 19. Banknote transporting unit 25 includes a transporting unit 28 which is structured by an upper transporting section 26 and a lower transporting section 27, and is located in parallel. However, if the banknote 9 can be transported straight, the transporting unit 28 need only use one transporting section.

Upper transporting section 26 includes pulleys 31, 32 which are attached on upper member 3 and are rotatable. Lower transporting section 27 includes pulleys 34, 35 and 36 and belt 37 which are belted by the pulleys. Pulleys 31 and 32 are resiliently supported towards lower member 2, and have contact with lower belt 37 to face pulleys 34, 35 at a predetermined pressure.

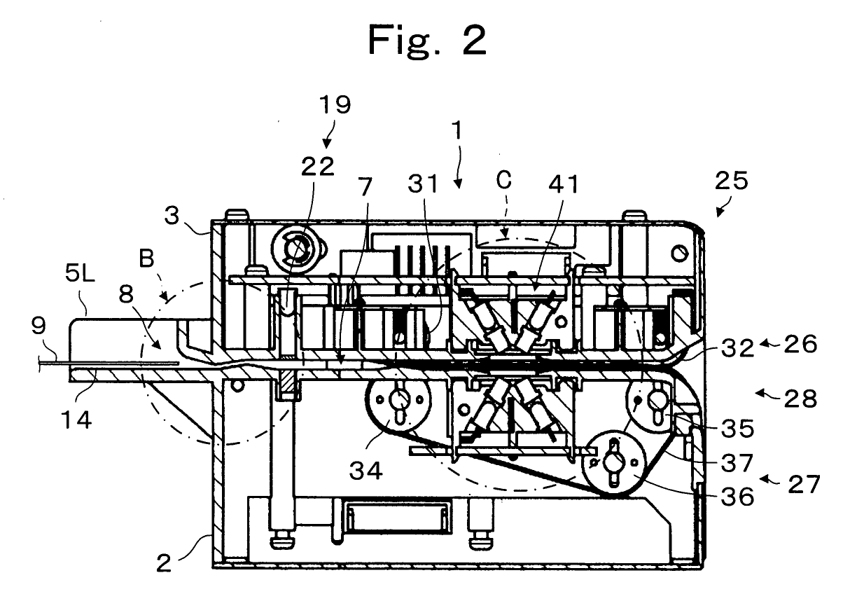

Pulley 36 is coupled to the output shaft of a motor (not shown). When banknote 9 is accepted, pulley 36 is driven by a motor in the clockwise direction as shown in FIG. 2. Therefore, banknote 9 is pinched by lower belt 37 and pulleys 31 and/or 32, is transported to the right along the axis of banknote passageway 7.

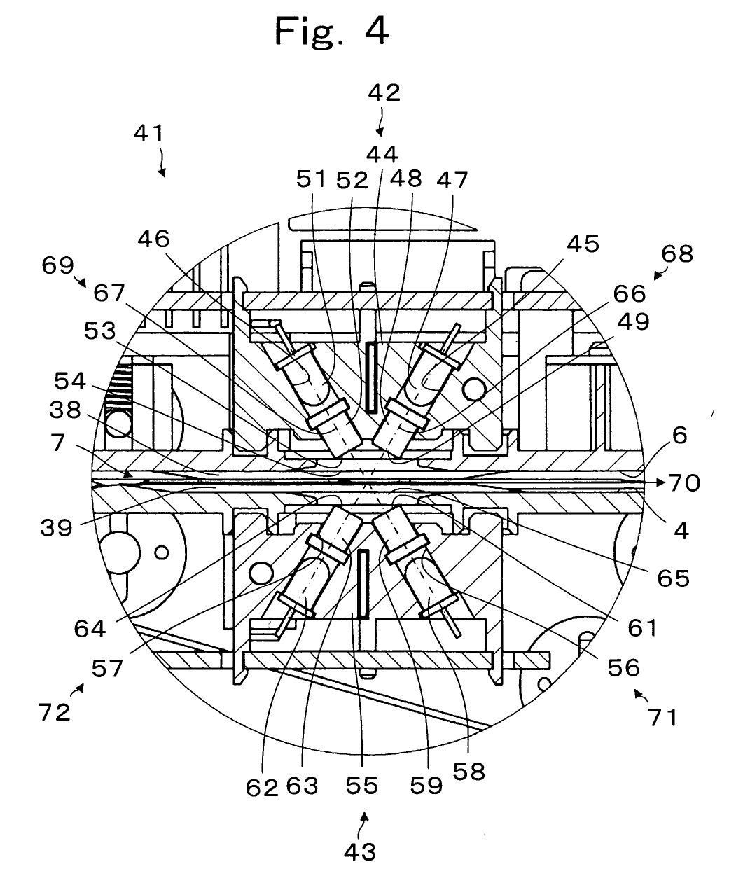

If banknote 9 is to be returned, pulley 36 is rotated in the opposite direction, and is transported in the left. As shown in FIG. 4, upper banknote stabilizer 38 is formed corresponding to the middle section of lower belt 37. Upper banknote stabilizer 38 extends from upper banknote guiding surface 6 to lower banknote guiding surface 4 and in the transporting direction of banknote 9.

Lower banknote stabilizer 39 faces an upper banknote stabilizer 38 and extends from lower banknote guiding surface 4 to upper banknote guiding surface 6. The distance between the end of upper banknote stabilizer 38 and the end of lower banknote stabilizer 39 is a thickness of a few banknotes 9. Also, it has two functions which flatten the banknote 9 and keep an approximately constant distance between the after-mentioned an emitting sensor and a reflecting sensor.

Banknote detecting unit 41 is located at banknote passageway 7 where a banknote is transported by the banknote transporting unit 25. Banknote detecting or verification unit 41 of this present invention includes a first emitting sensor 68, first reflecting sensor 69, a second emitting sensor 71 and a second reflecting sensor 72. These sensors are structured by upper sensor unit 42 which is fixed at upper member 3 and lower sensor unit 43 which is fixed at lower member 2.

Upper sensor unit 42 and lower sensor unit 43 are the same structure and are located symmetric to an up and down direction referring to banknote passageway 7. First, upper sensor unit 42 is explained. First emitting attaching hole 45 is formed at first sensor body 44, and its axis line crosses to banknote passageway 7 in an obtuse angle towards banknote entry 8. First receiving attaching hole 46 is formed upstream to hole 45, and the axis line crosses to banknote passageway 7 at an acute angle.

First light emitting element 47 is fixed at the bottom (top) of first emitting attaching hole 45. First light emitting element 47 is, for example, a red light emitting diode. First emitting protecting cover 48 is fixed at the end of first emitting attaching hole 45 and is made of a transparent resin, for example, acrylate resin or glass and is cylindrical. In other words, first emitting section 49 is the end of first emitting protecting cover 48. After-mentioned protecting covers are made up as the same to first emitting protecting cover 48. Second light receiving element 51 is fixed at the bottom (top) of first receiving attaching hole 46. Second light receiving element 51 is, for example, light or photo transistor.

Second receiving protecting cover 52 is fixed at the end of first receiving attaching hole 46. In other words, second light receiving section 53 is the end of second receiving protecting cover 52. Second light receiving section 53 faces towards the rear to banknote entry 8; therefore, it doesn't receive outside light.

First light emitting section 49 and second light receiving section 53 protrude downwards from the undersurface of first sensor body 44 and face the upper opening 54 which is formed at upper banknote guiding surface 6. When first light emitting section 49 and second light receiving section 53 protrude from first sensor body 44, first light emitting section 49 and second light receiving section 53 can be cleaned. Therefore, the adhered dust both on first light emitting section 49 and second light receiving section 53 can be wiped away. As a result, the sensor function is recovered easy.

Next lower sensor unit 43 is explained. Second emitting attaching hole 56 is formed at second sensor body 55, and the axis line crosses to banknote passageway 7 at an obtuse angle towards banknote entry 8. Second receiving attaching hole 57 is formed upstream at hole 56, and the axis line crosses at banknote passageway 7 in an acute angle.

Second light emitting element 58 is fixed at the bottom of second emitting attaching hole 56. Second light emitting element 58 is, for example, a red light emitting diode. Second emitting protecting cover 59 is fixed at the end of second emitting attaching hole 56. In other words, second emitting section 61 is the end of second emitting protecting cover 59. First light receiving element 62 is fixed at the bottom of second receiving attaching hole 57. First light receiving element 62 is, for example, a light transistor.

First receiving protecting cover 63 is fixed at the end of second receiving attaching hole 57. In other words, first light receiving section 64 is the end of first receiving protecting cover 63. First light receiving section 64 faces towards the rear of banknote entry 8; therefore, it doesn't receive outside light. Second light emitting section 61 and first light receiving section 64 protrude upwards from the upper surface of second sensor body 55 and face toward to the lower opening 65 which is formed at lower banknote guiding surface 4.

First light receiving section 64 is located on first light axis 66 of first light emitting section 49. Second light receiving section 53 is located on second light axis 67 of second emitting section 61. Therefore, first light axis 66 and second light axis 67 cross at transporting line 70 of banknote 9 at banknote passageway 7 at an obtuse angle, and respectively are X-like in shape.

By this, first light emitting section 49 and first light receiving section 64 for the structure of first light emitting sensor 68, and first light emitting section 49 and second light receiving section 53 form the structure of first reflecting sensor 49. Also, second light emitting section 61 and second light receiving section 53 form the structure of second emitting sensor 71, and second light emitting section 61 and first light receiving section 64 structure second reflecting sensor 72.

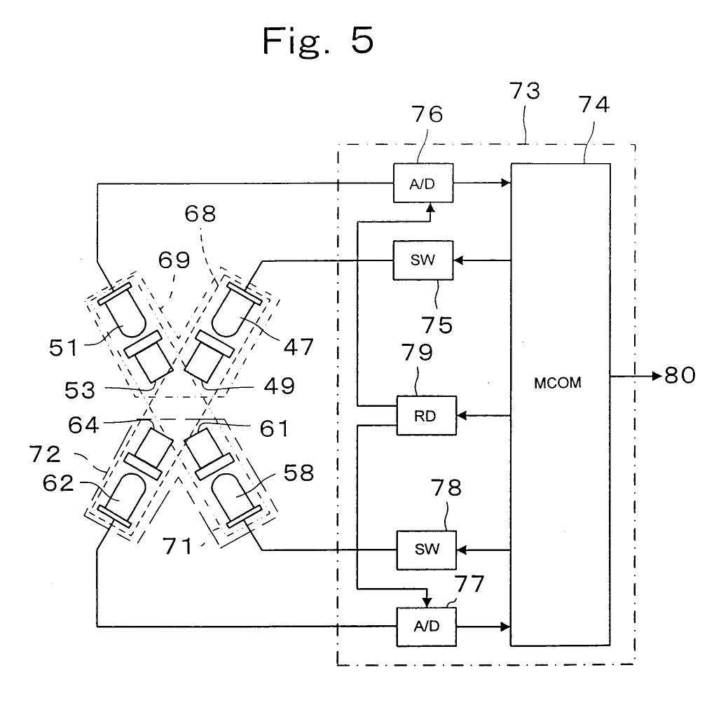

Next, banknote detecting circuit 73 is explained by referring to FIG. 5. Banknote detecting circuit 73 includes a first switching circuit 75, a second switching circuit 78, first A/D converting circuit 77, second converting circuit 76 and reading controlling circuit 79. First switching circuit 75 controls lighting of the first light emitting element 47 based on the direction of signals from microprocessor 74. Second switching circuit 78 controls lighting of second light emitting element 58 based on the direction of signals from microprocessor 74. First A/D converting circuit 77 converts from an analog signal of the first light receiving element 62 to a digital signal, then the digital signal is outputted to microprocessor 74. Second A/D converting circuit 76 converts from an analog signal of second light receiving element 51 to a digital signal, then the digital signal is outputted to microprocessor 74. Reading controlling circuit 79 controls the outputting of first A/D converting circuit 77 and second A/D converting circuit 76 to microprocessor 74.

Also, reading controlling circuit 79 can sample the output of both the first A/D converting circuit 77 and the second A/D converting circuit 76 based on the pre-stored program of the microprocessor 74.

Microprocessor 74 can output an authentic document signal 80 to banknote 9 based on the sampling data received from both the first A/D converting circuit 77 and the second A/D converting circuit 76. The microprocessor or control unit 74 activates the emission of radiation during passage of the document in a manner to avoid any interference in received signals. The control unit 74 can store a predetermined set of data representative of a valid document and can compare the measured set of data to determine if the document is within a predetermined range of values. Starting sensor 19 outputs the initial banknote signal to microprocessor 74. Then microprocessor 74 controls the motor (not shown) of banknote transporting unit 25 based on the banknote signal to start the verification procedure.

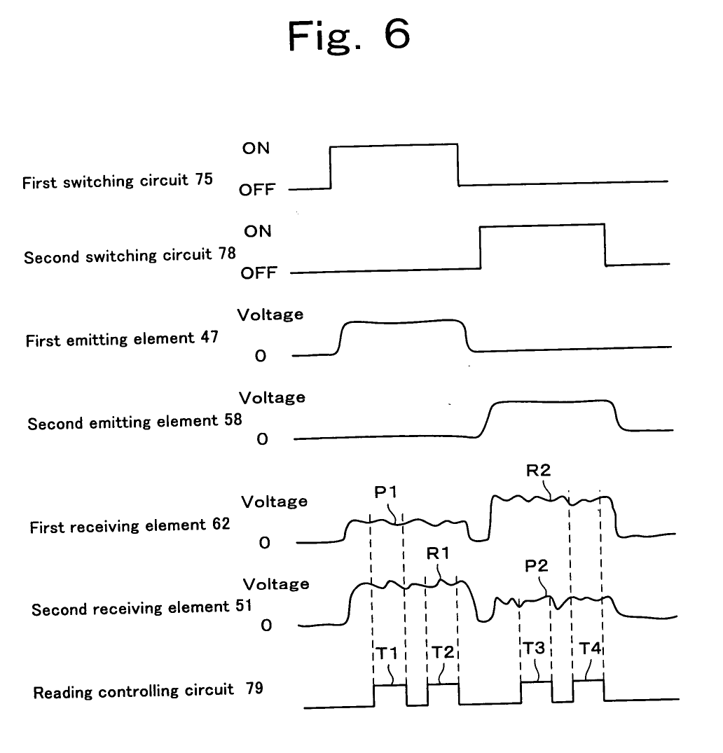

Next, the operation of the embodiment is explained referring to the timing chart in FIG. 6. Banknote 9 is put on flat surface 14 and the left edge is moved along left guiding board 5L. When banknote 9 is a maximum width, the right edge is guided by right guiding board 5R. When the width of banknote 9 adapts to guiding rib 18, the right edge is guided by guiding rib 18.

The end of banknote 9 is guided by downward projection 13 and upward projection 17, and moves in a zigzag direction, and comes to starting sensor 19. The beam of starting emitting/receiving element 22 is cut off by banknote 9. Accordingly, microprocessor 74 drives the motor (not shown), and banknote transporting unit 25 starts.

Banknote 9 is moved into the path between pulley 32 and belt 37. Afterwards banknote 9 is transported by pulley 31 and belt 37 (in the right direction in FIG. 2). In this process, banknote 9 is guided into the narrow path between the end of upper banknote stabilizer 38 and the end of lower banknote stabilizer 39. If the banknote 9 has a crease, banknote 9 is stretched flat. Accordingly, the distances between banknote 9 and first emitting sensor 68, first reflecting sensor 69, second emitting sensor 71, second reflecting sensor 72 become approximately constant. Afterwards banknote 9 is transported by pulley 32 and belt 37.

First switching circuit 75 and second switching circuit 78 are alternated “on” and “off” by microprocessor 74 until banknote 9 passes through from starting sensor 19 to banknote detecting unit 41. In other words, first light emitting element 47 is turned on by a drive circuit (not shown) and emits light at a predetermined time period; afterwards second light emitting element 58 is turned on by a drive circuit (not shown), and emits light at a predetermined time period. The processing is alternated along the entire length of banknote 9 in a short time period.

In other words, a beam of radiation is emitted from first light emitting element 47, and passes through first emitting section 49, afterwards crosses banknote passageway 7, then goes into first light receiving section 64. Afterwards, the beam is received into the first light receiving element 62 and is converted to an electrical signal P1 corresponding to the received light amount. The receiving light amount is at a low level, because the beam physically passes through the body of the banknote 9. At the same time, the emitted beam from first light emitting element 47 is reflected by the surface of banknote 9; afterwards it is received by second receiving section 53, and then is converted to an electrical signal R1 corresponding to the receiving light amount by second receiving element 51. The received light amount of second receiving section 53 is higher than the amount of first receiving section 64, because it is based on the reflecting light.

When second light emitting element is turned on by electricity, it emits light. The beam is emitted from second light emitting element 58, and passes through second emitting section 61, afterwards crosses banknote passageway 7, then goes into second light receiving section 53. Afterwards, the beam is received into second light receiving element 61 and is converted to electrical signal P2 corresponding to the received light amount. At the same time, the emitted beam from second light emitting element 58 is reflected by the reverse of banknote 9, and afterwards is received in the first receiving section 64, then is converted to an electrical signal R2 corresponding to the receiving light amount by first receiving element 62.

Analog outputs P1 and P2 of first light receiving element 62 are converted to digital signals by first A/D converting circuit 77, and are outputted to microprocessor 74. Also, analog outputs R1 and R2 of second light receiving element 51 are converted to digital signals by second A/D converting circuit 76, and are outputted to microprocessor 74.

Digital data which is based on the output of first light receiving element 62 is outputted to microprocessor 74 at timing signal T1 which is outputted by reading controlling circuit 79 based on the signal of microprocessor 74 and afterwards is sampled. Next, at timing signal T2, the signal corresponding to signal R1 of first reflecting sensor 69 is sampled in the same manner.

Also, at timing signal T3, the signal corresponding to signal P2 of second emitting sensor 71 is sampled. Next, at timing signal T4, the signal corresponding to signal R2 of second reflecting sensor 72 is sampled in the same manner. Above-mentioned sampling operations are executed at a predetermined times along the length of banknote 9. Afterwards, the authenticity of the banknote 9 is distinguished based on the comparison of sampling data with predetermined values representative of the banknote 9 in the microprocessor 74, and an authenticity signal 80 is outputted if a valid banknote is found.

As is clear from this embodiment, first emitting section 49 of both the first emitting sensor 68 and first reflecting sensor 49 and second emitting section 61 of both the second emitting sensor 71 and second reflecting sensor 72 have a commonality in function. When a pair of the emitting sensors and reflecting sensors are used, the emitting section and the receiving section can be reduced by two elements from the prior art. Therefore, the installation area is reduced and the price is reduced. Also, when firstly the data either of first emitting sensor 68 or second emitting sensor 71 is sampled, and secondly the data either of first reflecting sensor 68 or second reflecting sensor 72 is sampled, two sets of data can be detected based on the data of first emitting sensor 68 and second emitting sensor 71; afterwards the data either of first reflecting sensor 69 or second reflecting sensor 72 can be used to verify the authenticity of the document. Therefore, distinguishing accuracy increases.

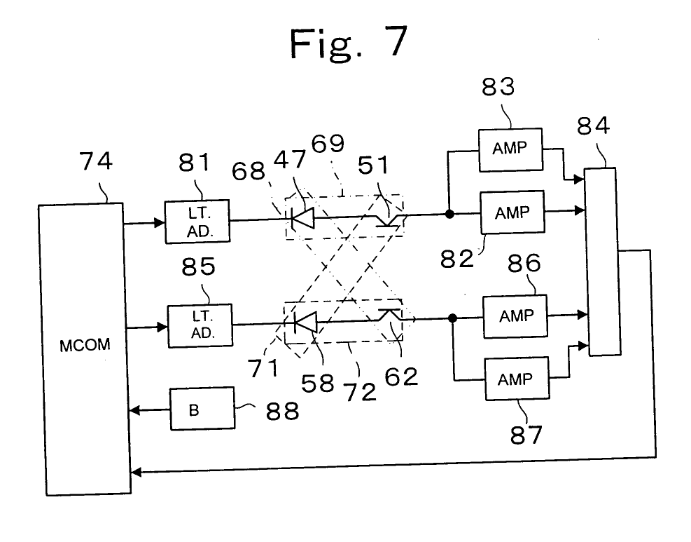

Next, an initial adjustment of banknote detecting unit 41 is explained referring to FIG. 7. The emitting amount of first light emitting element 47 is adjusted by the first light emitting adjusting circuit 81 which is an emitting adjusting unit. The output of first light emitting adjusting unit 81 is controlled by microprocessor 74. The output of second light receiving element 51 is adjusted by both amplifier 82 for the second emitting sensor 71 and amplifier 83 for the first reflecting sensor 69. The output of both the amplifier 82 for the second emitting sensor 71 and amplifier 83 for the first reflecting sensor 69 are converted from an analog signal to a digital signal by third A/D converting circuit 84 and afterwards it is outputted to microprocessor 74. Amplifier 83 for first reflecting sensor 69 is a receiving outputting adjusting unit.

The emitting amount of second light emitting element 58 is adjusted by second light emitting adjusting circuit 85 which is an emitting adjusting unit. The output of second emitting adjusting circuit 85 is controlled by microprocessor 74. The output of first light receiving element 62 is adjusted by both amplifier 86 for the first emitting sensor and amplifier 87 for the second reflecting sensor. The output both of amplifier 86 for the first emitting sensor and amplifier 87 for the second reflecting sensor are converted from analog signals to digital signals by third A/D converting circuit 84 and afterwards they are outputted to microprocessor 74. Amplifier 87 for second reflecting sensor is a receiving outputting adjusting unit.

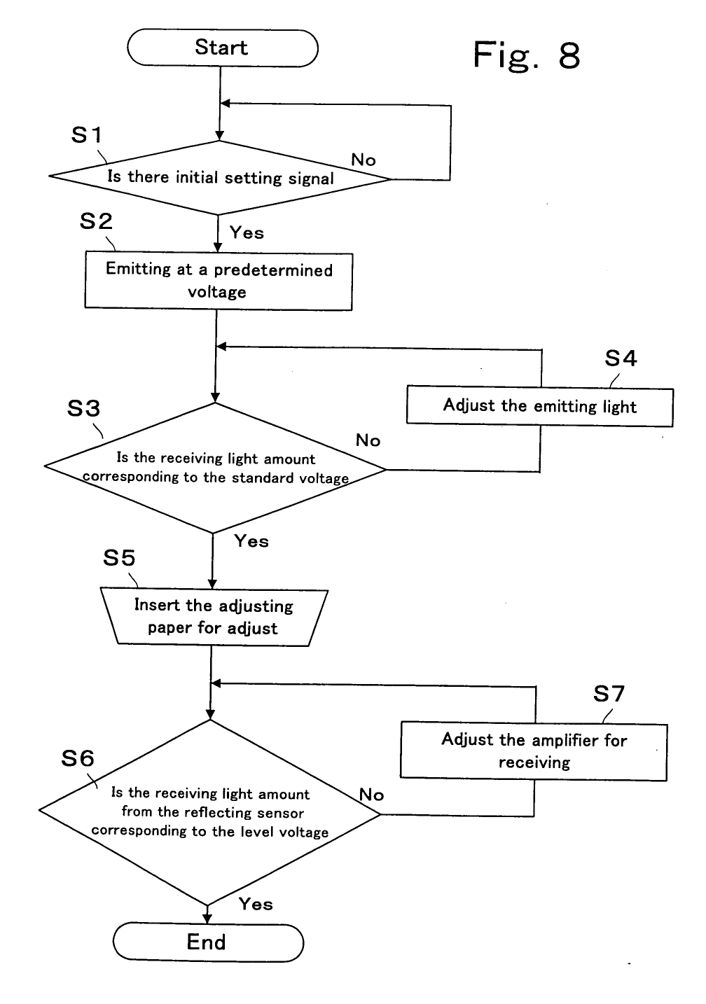

The initial setting can be started by pushing an initial setting button 88. Next the initial setting of banknote detecting unit 41 is explained by referring to FIG. 8. The initial setting of first emitting sensor 68, first reflecting sensor 69, second emitting sensor 71 and second reflecting sensor 72 are the same. Therefore, the initial setting of both of first emitting sensor 68 and first reflecting sensor 69 are explained. Firstly, initial setting button 88 is pushed, and initial setting signal IN is sent to microprocessor 74.

As shown in FIG. 8, at step S1, when initial setting signal “IN” is distinguished, the program goes to step S2 and first light emitting element 47 emits at a predetermined voltage. The output of first light receiving element 62 is amplified at a predetermined gain by amplifier 86 for the first emitting sensor. The amplified signal is converted to a digital signal by third A/D converting circuit 84, and afterwards it is outputted to microprocessor 74. At step S3, the output of amplifier 86 for first emitting sensor is compared to a predetermined standard voltage. When the output does not corresponding to the standard voltage, the program goes to step S4. At step S4, when the output is larger than the standard voltage, the current is adjusted to reduce the light amount by first light amount adjusting circuit 81. When the output is smaller than the standard voltage, the current is adjusted to increase the light amount by first light amount adjusting circuit 81. By this adjustment, when the receiving light of first light receiving element 62 becomes a predetermined light amount, the program goes to step S5. In other words, when the voltage of amplifier 86 reaches at a predetermined voltage, the program goes to step S5.

At step S5, a standard calibrating paper for adjusting is inserted into banknote passageway from banknote entry 8. Also, the standard paper is transported by banknote transporting unit 25 in the same manner as banknote 9. Afterwards, the standard paper is returned to the banknote entry in the same manner as a rejected fake banknote. In this process, the output of second light receiving element 51 is amplified by amplifier 83 for the first reflecting sensor, and is converted to a digital signal by third A/D converting circuit 84, and afterwards is outputted to microprocessor 74.

At step S6, the digital signal is compared to the standard level voltage. When the digital signal does not correspond to the standard voltage, the program goes to step S7. When the digital signal exceeds the standard voltage, the gain of amplifier 83 for first reflecting sensor is reduced to correspond to the standard voltage. By this, the initial setting operation is completed. Also, the standard voltage can be set at a predetermined range.

The present invention can use a beam of radiation which is at a first wavelength at the first emitting section and another beam which is at a second wavelength at the second emitting section. In this case, an emitting data, a reflecting data which is based on the first wave and another emitting data, another reflecting data which is based on the second wave can be received. In other words, it is possible to generate four different data's sets in different situations. Therefore, the authenticity accuracy of verifying the banknotes can be increased. The number of the banknote detecting units can be increased at width and length of the banknote. As a result, the authenticity accuracy of the banknotes increases.

Also, the first emitting section can emit light which is infrared rays, and the second emitting section can emit light which is non-infrared rays. The cost of the infrared and the non-infrared light emitting element, for example, a red light emitting diode are relatively inexpensive. Therefore, the cost of the device is lowered. Also, only the first emitting sensor and the first reflecting sensor can be used in the banknote detecting unit. In this case, only one of the light emitting element is reduced.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A banknote detecting unit for a banknote distinguishing device comprising:
a transmitting sensor unit which includes a light emitting section and a light receiving section which are located on an optical axis of the light emitting section and positioned on opposite sides to a banknote passageway,
a reflecting sensor unit which includes a light transmitting section and a light receiving section which are located on one side of the banknote passageway which is characterized in that: a first transmitting sensor is structured by a first optical axis of a first light emitting section which slants relative to the banknote passageway and a first light receiving section which is located on the first optical axis and is located opposite the first light emitting section,
a first reflecting sensor which is structured by the first light emitting section and a second light receiving section which is located on the same side as the first light emitting section relative to the banknote passageway.

2. The banknote detecting unit for the banknote distinguishing device claimed in claim 1 wherein the first optical axis crosses at an obtuse angle relative to the banknote's traveling direction.

3. The banknote detecting unit for the banknote distinguishing device claimed in claim 1 further includes a second light emitting section which is located opposite to the first light emitting section along the banknote passageway, the second light emitting section is located on a second optical axis.

4. The banknote detecting unit for the banknote distinguishing device claimed in claim 3 wherein a first wavelength light is projected from the first light emitting section, and a second wavelength light is projected from the second light emitting section.

5. The banknote detecting unit for the banknote distinguishing device claimed in claim 4 wherein the first light emitting section projects infrared light radiation, and the second light emitting section emits non-infrared light radiation.

6. The banknote detecting unit for the banknote distinguishing device claimed in claim 4:
further includes a reading controlling unit which, when the first light emitting section emits rays, a receiving output of the first receiving section is read, and afterwards emitting from the first emitting section stops, when the second light emitting section emits rays, the receiving output of the second light receiving section is read, and afterwards the receiving output of the first light receiving section is read.

7. The banknote detecting unit for the banknote distinguishing device comprising:
a first transmitting sensor is structured by a first light emitting section which slants at a first light axis to a banknote passageway and a first light receiving section which is located on the first light axis and is located opposite the first light emitting section relative to the banknote passageway,
a first reflecting sensor which is structured by the first light emitting section and a second light receiving section which is located on the same side of the first light emitting section relative to the banknote passageway,
an emitting amount adjusting unit which adjusts an emitting amount, when the first light emitting section emits an output of the first light receiving section at a predetermined amount, and
a receiving outputting adjusting unit which adjusts a gain to the output of the second light receiving section when the output reaches a predetermined amount from the second light receiving section.

8. In a document verification system for receiving and verifying the authenticity of a document adjacent a document passageway, the improvement comprising:
a transmitting sensor assembly for emitting radiation to contact a document operatively positioned relative to the document passageway including a first radiation emitting section on one side of the document passageway and a first radiation receiving section on another side of the document passageway, the optical axis of the first radiation emitting section and first radiation receiving section is slanted relative to an axis of the document passageway; and
a reflecting sensor assembly for receiving reflected radiation from the document including a second radiation receiving section positioned on the same side of the document passageway as the first radiation emitting section and operatively positioned to receive reflected radiation after contact with the document wherein the first radiation receiving section receives radiation transmitted through the document.

9. In a document verification system for receiving and verifying the authenticity of a document adjacent a document passageway, the improvement comprising:
a first transmitting sensor assembly for emitting radiation to contact a document operatively positioned relative to the document passageway including a first radiation emitting section on a first side of the document passageway and a first radiation receiving section on a second side of the document passageway, a first optical axis of the first radiation emitting section and first radiation receiving section is slanted relative to an axis of the document passageway;
a first reflecting sensor assembly for receiving reflected radiation from the document including a second radiation reflection receiving section positioned on the first side of the document passageway and operatively positioned to receive reflected radiation after contact with the document wherein the first radiation receiving section receives radiation transmitted through the document;
a second transmitting sensor assembly for emitting radiation to contact a document operatively positioned relative to the document passageway including a second radiation emitting section on a second side of the document passageway and a second radiation receiving section on the first side of the document passageway, a second optical axis of the second radiation emitting section and second radiation receiving section is slanted relative to an axis of the document passageway and crosses the first optical axis;
a second reflecting sensor assembly for receiving reflected radiation from the document including a third radiation reflection receiving section positioned on the second side of the document passageway and operatively positioned to receive reflected radiation after contact with the document wherein the second radiation receiving section receives radiation transmitted through the document; and
a control unit to activate the first radiation emitting section and the second radiation emitting section in a manner to avoid interference between the emitted radiation.

10. The document verification system of claim 9 wherein the first radiation emitting section emits light at a first wavelength and the second radiation emitting section emits light at a second wavelength different than the first wavelength.

11. The document verification system of claim 9 wherein the control unit activates the first radiation emitting section and the second radiation emitting section multiple times during a transit of a document to provide a set of data representative of the document to be verified.

12. The document verification system of claim 11 wherein the control unit stores a predetermined set of data representative of a valid document and compares the set of data representative of the document to be verified and issues a verification signal if the comparison is within predetermined ranges.
